(19) United States
(12) Patent Application Publication
(10) Pub. No.: US 2025/0251510 A1
(43) Pub. Date: Aug. 7, 2025

(54) Method For Operating A Radar Sensor Device For A Motor Vehicle, And Radar Sensor Device

(71) Applicant: Volkswagen Aktiengesellschaft, Wolfsburg (DE)

(72) Inventors: Marc-Michael Meinecke, Sassenburg (DE); Heiko Gustav Kurz, Hannover (DE); Thomas Gisder, Wolfsburg (DE)

(73) Assignee: Volkswagen Aktiengesellschaft, Wolfsburg (DE)

(21) Appl. No.: 19/043,819

(22) Filed: Feb. 3, 2025

(30) Foreign Application Priority Data
Feb. 2, 2024 (DE) 10 2024 200 983.0

(51) Int. Cl. G01S 13/88; G01S 13/28

(52) U.S. Cl. CPC G01S 13/88; G01S 13/282

(57) ABSTRACT

The disclosure relates to a method for operating a radar sensor device for a motor vehicle, comprising: generating a first detection signal with a first frequency for detecting surroundings of the motor vehicle by means of a processor; modulating the first detection signal onto an optical carrier signal by means of the processor; transmitting the optical carrier signal with the modulated first detection signal to a transmitter of the radar sensor device by means of the processor; frequency-converting the first detection signal to a second detection signal with a second frequency that is different from the first frequency by means of the transmitter; and emitting the first detection signal into the surroundings by a first transmission antenna of the transmitter and emitting the second detection signal into the surroundings by means of a second transmission antenna of the transmitter.

### CROSS-REFERENCE TO RELATED APPLICATIONS

This application claims priority to German Patent Application DE 10 2024 200 983.0, filed on Feb. 2, 2024 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a method for operating a radar sensor device for a motor vehicle. Furthermore, the disclosure relates to a radar sensor device.

It is known from the prior art that, in lidar sensors or also radar sensors, for example, wave signals are emitted in the surroundings and are, in turn, reflected on objects and can thus be used, for example, to detect the surroundings.

The intensity of the emitted waves, in particular, plays a role here, since due to legal requirements it is not possible for the intensity to be high enough to suitably protect people or animals in the surroundings.

It is further known that, for a better resolution of the surroundings, for example, multiple radar sensor devices are used which then emit radar signals into the surroundings at different frequencies. As a result, it is possible, for example, to carry out detection at short range, medium range, and long range.

### SUMMARY

A need exists to provide a method and a radar sensor device for a motor vehicle using which improved detection of the surroundings is made possible.

The need is addressed by the subject matter of the independent claim(s). Embodiments of the invention are described in the dependent claims, the following description, and the drawings.

### BRIEF DESCRIPTION OF THE DRAWINGS

FIG. 1 shows a schematic perspective view of an embodiment of a motor vehicle comprising an embodiment of a radar sensor device;

FIG. 2 shows a schematic block diagram of an embodiment of a radar sensor device;

FIG. 3 shows a schematic block diagram of an embodiment of a transmitter;

FIG. 4 shows a schematic block diagram of an embodiment of a receiver;

FIG. 5 shows a schematic block diagram of a further embodiment of a transmitter;

FIG. 6 shows a schematic block diagram of a further embodiment of a receiver;

FIG. 7 shows a schematic block diagram of yet another embodiment of a transmitter; and

FIG. 8 shows a schematic block diagram of another embodiment of a transmitter and a receiver.

Some embodiments of the disclosure relate to a method for operating a radar sensor device for a motor vehicle. A first detection signal with a first frequency for detecting surroundings of the motor vehicle is generated by means of an electronic processor (also referred as ‘computing apparatus’ herein). The first detection signal is modulated onto an optical carrier signal by means of the electronic processor. The optical carrier signal with the modulated first detection signal is transmitted to the transmitter (also referred to as ‘transmission apparatus’ herein) of the radar sensor device by means of the electronic processor. A frequency conversion of the first detection signal to a second detection signal with a second frequency that is different from the first frequency is carried out by means of the transmitter and the first detection signal is emitted into the surroundings by means of a first transmission antenna of the transmitter and the second detection signal is emitted into the surroundings by means of a second transmission antenna of the transmitter.

Thus it is made possible for two detection signals to be emitted into the surroundings. In particular, the first detection signal and the second detection signal are designed to be different in terms of their frequency. Therefore, a low-frequency detection signal and a higher-frequency detection signal, for example, can be emitted into the surroundings. This makes it possible, for example, for corresponding detection of, for example, objects in the surroundings to be carried out both at shorter ranges and at longer ranges.

Some embodiments make use of the fact that, for example, miniaturized radar chips can be used in a coherently distributed, thinned array that is integrated over a large area on the vehicle. Conversion of the optically transmitted radar signal on, for example, an electronic-photonic co-integrated semiconductor chip then takes place into at least two different frequencies in some embodiments. Then, the corresponding detection signals with the two frequencies are emitted into the surroundings by means of the transmission antennae and the corresponding chips are optically connected to form a coherent overall system. Then, detection of a target or else object in the surroundings can be realized, in particular in the two frequency bands.

It is beneficial, in particular, that a high signal-to-noise ratio can be realized in some embodiments. Furthermore, low phase noise and flexible chip generation can be realized in some embodiments. Equally, it is possible for a small number of optical fibers to be provided. This may result, in particular, in a cost saving, a higher resolution, and a higher range.

The teachings herein in particular solve the problem that, due to physical interrelationships, the angular resolution of a radar system or else radar device is determined by the extent of the antenna equipment thereof. Current radar sensor devices are mostly modules having a size of around 10×10 cm², which is restricted due to the integrability in motor vehicles. The angular resolution is accordingly limited to approximately two degrees in the ideal case. Here, the resolution improves proportionally to the size of the equipment. If two objects are to be resolved in angle, in particular in azimuth and elevation, equipment that is extended in two directions is beneficial.

A second variable in an antenna array is the spacing between the corresponding elements. This determines the clearly measurable angular range. Larger antenna spacings lead to ambiguities, in particular so-called side peaks, in the angle measurement. Modern radar sensor devices in the automotive industry thus use so-called virtual antenna elements. A virtual element of this kind results from the combination of a transmission antenna with a receiving channel and specifically exactly on the center of the connection vector. With n-transmission antennae and m-receiving antennae, a virtual array consisting of a maximum of n×m elements can be produced. This principle is, in particular, also known as a so-called multiple input multiple output (MIMO).

In order to detect the surroundings as reliably as possible and in some embodiments, a signal-to-noise ratio that is as high as possible and stable signal generation in the sensor are beneficial. This is beneficial, in particular, in the case of large equipment with a thinned antenna arrangement, in order to detect targets clearly.

Furthermore, modern radar sensor devices, for example in the 77 gigahertz range, may be restricted in terms of their range due to the maximum emitted power and the array pattern. In particular, the radar systems in the prior art are limited to individual frequency bands. Typically, 77 gigahertz or 24 gigahertz are used for this in the motor vehicle industry. However, both frequencies are restricted in terms of their maximum range due to the maximum emitted power. Furthermore, two different photonic-electronic semiconductor chips are used for the transmission and reception channel (Tx and Rx), which results in further cost expenditures.

On account of the above-mentioned features, the corresponding issues, in particular, can be removed.

In some embodiments, the first detection signal and the second detection signal are emitted at the same time. In particular, corresponding simultaneous reflections of the first detection signal and of the second detection signal can therefore also be detected. On account of the simultaneous emission of the detection signals, it is possible to transmit the detection signals simultaneously, for example for a shorter range and for a longer range, and thus in different frequency bands. This allows for reliable detection of the surroundings.

In some embodiments, the first detection signal and the second detection signal are emitted at different points in time. For example, the first detection signal may be emitted at a first point in time and the second detection signal may be emitted at a second point in time following on from a first point in time. This allows for improved assignment of the reflection signals, in particular in the corresponding evaluation, as a result of which objects in the surroundings can be detected in an improved manner.

For example, in some embodiments, it can be provided that, firstly, the two detection signals are emitted at the same time and, in a further time step, the detection signals are emitted at different points in time. Therefore, the benefits of the embodiments can be combined with one another.

In some embodiments, the second detection signal is emitted at a higher frequency than the first detection signal. For example, the first detection signal may have a frequency of 6 gigahertz. The second detection signal may have a frequency of 77 gigahertz. Therefore, ranges of up to 150 meters can be resolved accordingly, for example by means of the second detection signal. For longer ranges, the first detection signal can in turn be used. This allows for reliable detection of a large region in the surroundings of the motor vehicle.

In some embodiments, the transmitter is provided as an electronic-photonic co-integrated chip. In particular, a photonic co-integrated chip can therefore be integrated in miniaturized form in a coherently distributed, thinned array that is provided, in particular, over a large area on the motor vehicle. Cohesion of the optically transmitted radar signal on the electronic-photonic co-integrated semiconductor circuit can be realized in at least two different frequencies.

In some embodiments, the first detection signal and/or the second detection signal are amplified prior to emission by means of the transmitter. In particular, the transmitter may therefore have at least an amplifier (also referred to herein as ‘amplifier apparatus’). It can then be provided that the first detection signal is amplified by means of a first amplifier and/or the second detection signal is amplified by means of a second amplifier. Alternatively, the transmitted first detection signal, for example, can be amplified and then frequency conversion to the second detection signal takes place afterward. This allows for reliable emission of a corresponding detection signal into the surroundings.

In some embodiments, it is provided that, depending on the first detection signal, a reflected first reflection signal and, depending on the second detection signal, a reflected second reflection signal are received by means of a receiver of the radar sensor device. In particular, for this purpose, the radar sensor device comprises at least a receiver for receiving the reflected detection radiation. The different reflection signals are then received accordingly, and said reflection signals are supplied, for example, to the electronic processor, such that corresponding evaluation of the surroundings can be realized. In particular, objects in the surroundings can therefore be detected accordingly.

For this purpose, some embodiments provide that an evaluation of the first reflection signal and an evaluation of the second reflection signal can be carried out by means of the electronic processor. In other words, the corresponding reflection signals are transmitted from the receiver, for example via an optical carrier path, to the electronic processor. Evaluation then takes place within the electronic processor.

It is further beneficial if an individual evaluation of the first reflection signal and an individual evaluation of the second reflection signal are carried out by means of the electronic processor or a joint evaluation of the first reflection signal and of the second reflection signal is carried out. The individual evaluation may be, for example, an independent evaluation. In other words, the first reflection signal may be evaluated independently of the second reflection signal. In particular, a fusion of the evaluations may then in turn take place in order to be able to carry out a corresponding object allocation. Alternatively, it can be provided that a joint evaluation of the reflection signal is carried out within the electronic processor. Therefore, it is already possible, for example, to evaluate the reflection signals together, making reliable detection of the surroundings possible.

In some embodiments, it is provided that the first reflection signal and the second reflection signal are evaluated coherently or incoherently. A coherent evaluation allows for a finer resolution. Furthermore, this makes data fusion obsolete, since this has already been carried out intrinsically. Meanwhile, less computing power is required by the incoherent evaluation.

In some embodiments, the first transmission antenna and a first receiving antenna are co-integrated on a first element and/or the second transmission antenna and a second receiving antenna are co-integrated in a second element. In other words, the first element may be provided as a transmission antenna with an associated receiving antenna and the second element may be provided as a second transmission antenna with the associated second receiving antenna. In particular, the element may therefore serve alternately as a transmission antenna and receiving antenna. Therefore, the function of the transmission antenna and of the receiving antenna can be provided within a single element, for example within a so-called EPIC chip.

In some embodiments, the first reflection signal and the second reflection signal are modulated onto an optical carrier signal and transmitted to the electronic processor. In particular, the receiver may thus be designed to modulate the reflection signals onto the optical carrier signal. This makes it possible to reliably transmit the reflection signal to the electronic processor.

Some embodiments provide that the receiver is provided with a ring line. As a result, fewer fibers are needed.

In some embodiments, it is provided that, depending on the first detection signal, at least a third detection signal is frequency-converted and at least additionally the third detection signal is emitted into the surroundings. It is self-evident here that more than three detection signals may be generated accordingly. In particular, it is then also possible, for example, to generate each further detection signal in a frequency-converted manner depending on the first detection signal. In particular, the third detection signal then has a third frequency that is different from the first frequency and second frequency. As a result, a large number of frequency bands can be utilized to carry out corresponding detection of the surroundings.

The method presented may in some embodiments be provided, at least in part, as a computer-implemented method. Some embodiments of the disclosure therefore relate to a computer program product with program code which prompt a processor, when the program code is processed by the processor, to carry out the method as discussed herein or any of the related embodiment(s). Moreover, the disclosure also relates to a (e.g., non-transitory) computer-readable storage medium with instructions that when processed by the processor cause the processor to execute the method according to the teachings herein or any of the related embodiment (s).

For example, the generation of the detection signal in the electronic processor and the evaluation of the received reflection signals in the electronic processor may be provided as a computer-implemented method in corresponding embodiments.

For this purpose, the processor comprises, in particular, objective features for being able to carry out corresponding computer-implemented method steps.

Furthermore, some embodiments also relate to a radar sensor device for the motor vehicle, comprising at least an electronic processor and a transmitter, wherein the radar sensor device is designed to carry out the method as discussed herein or any related embodiment(s). In particular, the method is carried out by the radar sensor device in some embodiments.

Some embodiments relate to a motor vehicle comprising a radar sensor device according to the teachings herein.

The embodiments of the method should be considered to be embodiments of the computer program product, computer-readable storage medium, radar sensor device, and motor vehicle. For this purpose, the radar sensor device and the motor vehicle may comprise objective features for being able to carry out corresponding method steps.

For application scenarios or application situations which may result with the method and which are not explicitly described here, it can be provided that, according to some embodiments of the method, an error message and/or a request to input user feedback is output and/or a standard setting and/or a predetermined initial state is set.

Also belonging to the teachings herein are embodiments of the radar sensor device and of the motor vehicle that have features which have already been described in conjunction with the embodiments of the method according to the teachings herein. For this reason, the corresponding embodiments of the radar sensor device and of the motor vehicle will not be described again.

In the embodiments described herein, the described components of the embodiments each represent individual features that are to be considered independent of one another, in the combination as shown or described, and in combinations other than shown or described.

In addition, the described embodiments can also be supplemented by features other than those described.

Reference will now be made to the drawings in which the various elements of embodiments will be given numerical designations and in which further embodiments will be discussed. Specific references to components, process steps, and other elements are not intended to be limiting. Further, it is understood that like parts bear the same or similar reference numerals when referring to alternate FIGS. The FIGS. are schematic and not necessarily to scale.

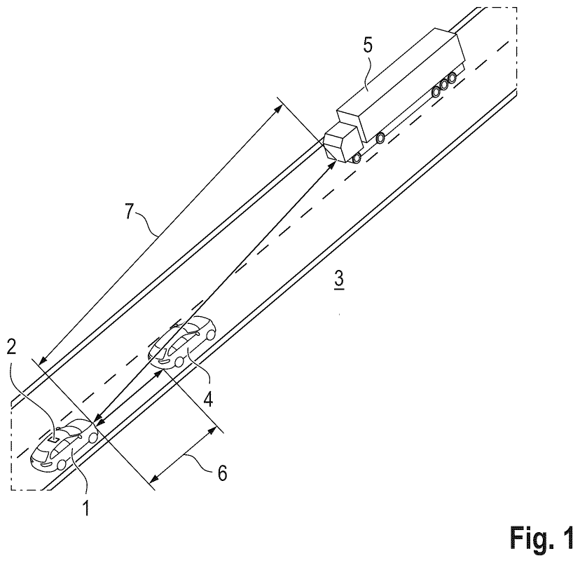

FIG. 1 is a schematic perspective view of an embodiment of a motor vehicle 1. The motor vehicle 1 comprises at least a radar sensor device 2. The radar sensor device 2 is designed to detect surroundings 3 of the motor vehicle 1. In the present exemplary embodiment, for example, a first object 4 is represented in front of the motor vehicle 1 as well as a second object 5, in particular an oncoming motor vehicle. The first object 4 is located at a first range 6 and the second object 5 is located at a second range 7.

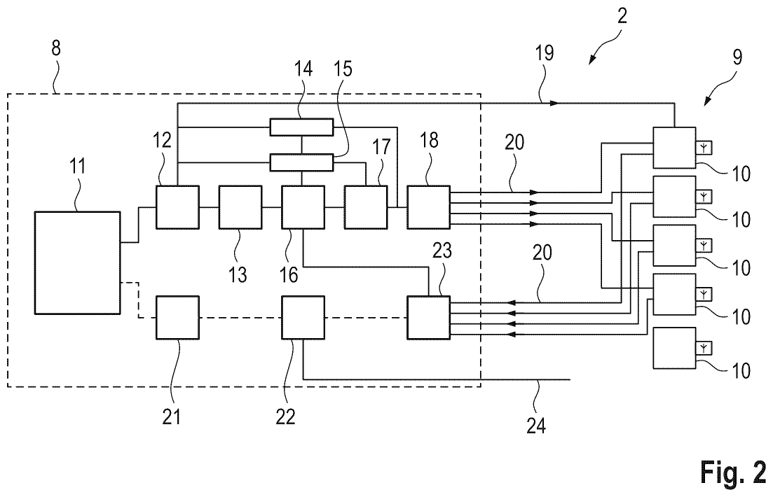

FIG. 2 is a schematic block diagram according to an embodiment of a radar sensor device 2. In the present exemplary embodiment, the radar sensor device 2 comprises at least a processor 8 and a transmitter 9. In the present exemplary embodiment, the transmitter 9 comprises a plurality of transmission antennae 10.

In the following embodiment, it is shown, in particular, that the method can be carried out on the basis of electronic-photonic co-integrated chips. In particular, the electronic-photonic co-integrated chips, which can also be referred to as EPIC chips, are provided as sensor elements.

FIG. 2 shows, in particular, that the radar sensor device 2 may comprise at least a central station as the electronic processor 8. The central station comprises at least a processor apparatus 11 as well as a control interface 12. Furthermore, an arrayed waveguide grating 13 is shown as an option. Furthermore, a low-level signal processor unit 21 is shown as an option. Furthermore, a digital interface 22, for example in the form of an analog-digital converter, is shown. The elements presented are, in particular, electronic elements. Furthermore, the central station also comprises photonic components. A feedback loop 14, for example, may optionally be provided. Moreover, a laser apparatus 15, a gigahertz synthesis unit 16, an optical control unit 17, an optical switch 18, and an optical detection apparatus 23 are shown. In particular, corresponding optical signals 20 are sent from the optical switch 18 to the EPIC chips. In turn, optical return signals 20 are sent from the EPIC chips to the optical detection apparatus 23. Moreover, another electronic output signal 19 to the EPIC chips is shown. Furthermore, an electronic backward channel 24 is shown.

In particular, FIG. 2 therefore shows the central station with transmitter and receiver chips on the right-hand side in a co-integrated design. The photonic components, for example the grating coupler and the photodiode for the transmitter as well as two grating couplers, a photodiode, and a modulator for the receiver, are shown in the electronic-photonic integrated circuits, in particular the EPIC chips, whereas the electronic components are for example represented on the left-hand side. The central station generates an optical carrier signal. Said signal is fed into the gigahertz synthesis unit 16, and the synthesized gigahertz signal is forwarded to the EPIC chips via fiber in the optical spectral range in order to be emitted, for example, as a 77 gigahertz signal. The signal detection takes place in reverse. All data are processed on the central station.

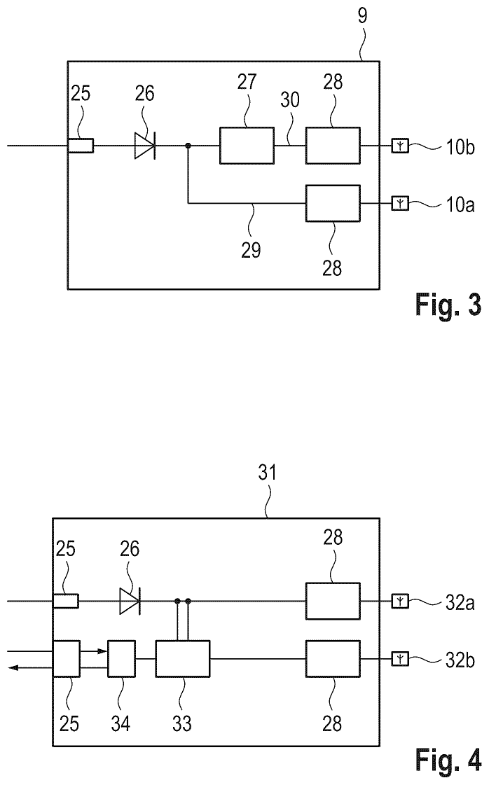

FIG. 3 is a schematic block diagram according to an embodiment of a transmitter 9. In the present exemplary embodiment, it is shown, in particular, that the transmitter 9 comprises a first transmission antenna 10a and a second transmission antenna 10b. Furthermore, FIG. 3 shows a photonic coupling element 25 and a photodiode 26.

According to this embodiment, a frequency conversion module 27 and a respective amplification module 28 are also shown.

In particular, the exemplary embodiment presently set out can be used to carry out a method for operating the radar sensor device 2. A first detection signal 29 with a first frequency for detecting the surroundings 3 is generated by means of the electronic processor 8. The first detection signal 29 is modulated onto an optical carrier signal by means of the electronic processor 8. The optical carrier signal with the modulated first detection signal 29 is transmitted to the transmitter 9. Then, the first detection signal 29 is frequency-converted to a second detection signal 30 with a second frequency that is different from the first frequency by means of the transmitter 9 and the first detection signal is emitted into the surroundings 3 by means of the first transmission antenna 10a and the second detection signal 30 is emitted into the surroundings 3 by means of the second transmission antenna 10b.

It can be provided that, for example, the first detection signal 29 and the second detection signal 30 are emitted at the same time. Alternatively, the first detection signal 29 and the second detection signal 30 may be emitted at different points in time. Furthermore, it is in particular provided that, for example, the second detection signal 30 is emitted at a higher frequency than the first detection signal 29. Furthermore, it is in particular provided that the transmitter 9 is provided as an electronic-photonic co-integrated chip. Moreover, FIG. 3 shows, in particular, that the first detection signal 29 and/or the second detection signal 30 is amplified prior to emission by means of the transmitter 9.

FIG. 4 is a schematic block diagram according to an embodiment of a receiver 31 of the radar sensor device 2. In this regard, the receiver 31 comprises a first receiving antenna 32a and a second receiving antenna 32b. For example, the first receiving antenna 32a may be designed to detect a first reflected first detection signal 29 and the second receiving antenna 32b is designed to detect the reflected second detection signal 30. For this purpose, the receiver 31 also comprises an amplification module 28. Furthermore, a mixer apparatus 33 is shown. Furthermore, FIG. 4 shows that the receiver 31 may comprise an optical modulator 34.

In particular, it is thus provided that, depending on the first detection signal 29, a reflected first reflection signal and, depending on the second detection signal 30, a reflected second reflection signal is received by means of the receiver 31 of the radar sensor device 2. It may further be provided that an evaluation of the first reflection signal and an evaluation of the second reflection signal can be carried out by means of the electronic processor 8. An individual evaluation of the first reflection signal and an individual evaluation of the second reflection signal can be carried out by means of the electronic processor 8. Alternatively, a joint evaluation of the first reflection signal and of the second reflection signal may be carried out.

It may further be provided that the first reflection signal and the second reflection signal are evaluated coherently or incoherently.

In particular, it is thus provided that a control signal and an optical signal are provided by means of the electronic processor 8, for example by means of the processor apparatus 11. An optical signal is then transmitted to the gigahertz frequency synthesis unit 16. The gigahertz signal is modulated onto an optical carrier signal and transmitted to the corresponding transmitter 9, which in particular comprises EPIC chips. The detection of the optical carrier signal in the EPIC chip is carried out by means of a photodiode 26 and corresponds to a frequency conversion in the low gigahertz spectral range, for example 6 or 9 gigahertz. The gigahertz signal is then forwarded into the two circuits according to FIG. 3. In the process, amplification of the low gigahertz spectral range and emission by means of the first transmission antenna 10a as well as frequency conversion, for example into the 77 gigahertz spectral range, amplification and emission by means of the second transmission antenna 10b take place. The electronic gigahertz signal is then forwarded to the corresponding transmission antennae 10a, 10b. The reflected radiation is then detected by means of the receiving antennae 32a, 32b and the reception signal is returned to the electronic processor 8 or else to the processor apparatus 11 by modulation to an optical carrier signal. The detection of the optical radiation in the electronic processor 8 may, for example, be carried out via ADC sampling and coherent processing. Individual and/or joint coherent and incoherent processing of the data from both frequency bands may take place. The data may, in turn, be forwarded, for example to an environment model.

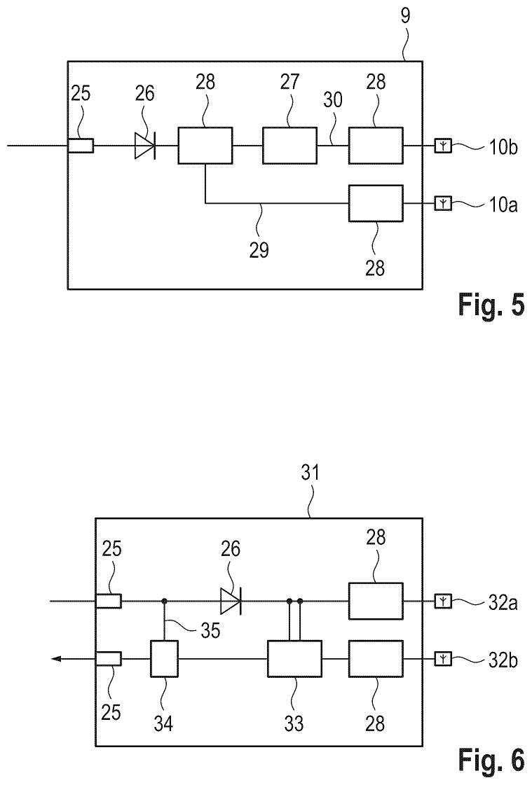

FIG. 5 shows a further embodiment of a transmitter 9. Unlike the exemplary embodiment from FIG. 5, it is shown, in particular, that a common amplification module 28 is provided downstream of the photodiode 26. After the amplification module 28, the corresponding detection signal 29 is then sent to the first transmission antenna 10a or else to the frequency conversion module 28, wherein further amplification may take place afterwards in each case.

FIG. 6 in turn shows that the receiver 31 may be designed having an optical ring line 35.

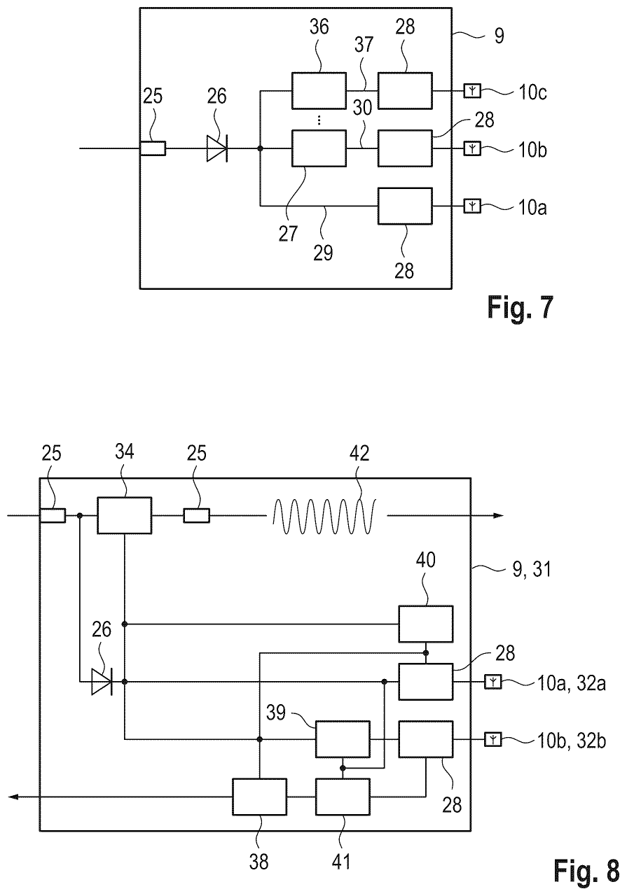

FIG. 7 is, in turn, a schematic block diagram of an embodiment of a transmitter 9. In the present exemplary embodiment, it is shown, in particular, that a further frequency conversion module 36 may be provided. In particular, a third detection signal 37 may thus be generated. In particular, it may therefore be provided that, depending on the first detection signal 29, at least the third detection signal 37 is frequency-converted and at least additionally the third detection signal 37 is emitted into the surroundings 3, in particular with a third transmission antenna 10c.

FIG. 8 is, in turn, a schematic block diagram of an embodiment of a transmitter 9 having an integrated receiver 31. The following exemplary embodiment presents a schematic representation of a so-called EPIC semiconductor circuit with a combined transmission and receiving antenna 10a, 10b, 32a, 32b in multiple frequency bands. Switching takes place between the transmission and receiving mode by means of the electronic circuits. Furthermore, diagnosis circuits 38 may also be provided. For this purpose, a phase modulator 39, a RF driver 40, and a BIAS module 41 may be provided. Moreover, a receiving antenna output signal 42 is shown, which can be sent back to the electronic processor 8, in particular the processor apparatus 11.

It may further be provided, in particular, that the corresponding EPIC chips or the transmitters 9 and receivers 31 may be arranged so as to be distributed over a large area on the motor vehicle 1, for example in a bumper, in a door, in a rocker panel, in a piece of roof equipment, in a piece of glass equipment, or in corresponding ABC pillars. In particular, these may be arranged on the entire vehicle surface, for example the windshield or rear window, and vehicle roof, bumper or the like. Various antennae for different spectral ranges may be integrated in the antenna modules themselves.

### LIST OF REFERENCE NUMERALS

1 Motor vehicle
2 Radar sensor device
3 Surroundings
4 First object
5 Second object
6 First distance
7 Second distance
8 Electronic processor
9 Transmitter
10 Transmission antennae
10a First transmission antenna
10b Second transmission antenna
10c Third transmission antenna
11 Processor apparatus
12 Control interface
13 Arrayed waveguide grating
14 Feedback loop
15 Laser apparatus
16 Gigahertz frequency synthesis block/module
17 Optical control unit
18 Optical switch
19 Electronic output signal
20 Optical signal
21 Low-level signal processor unit
22 Digital interface
23 Optical detector/optical detection apparatus
24 Electronic backward channel
25 Photonic coupling element
26 Diode
27 Frequency conversion block/module
28 Amplification module
29 First detection signal
30 Second detection signal
31 Receiver
32a First receiving antenna
32b Second receiving antenna
33 Mixer apparatus
34 Optical modulator
35 Ring line
36 Further frequency conversion block/module
37 Third detection signal
38 Diagnosis block/module
39 Phase modulator
40 RF driver
41 BIAS module

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the function of several items recited in the claims.

The term “exemplary” used throughout the specification means “serving as an example, instance, or exemplification” and does not mean “preferred” or “having advantages” over other embodiments. The term “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1. A method for operating a radar sensor device for a motor vehicle, comprising:
generating a first detection signal with a first frequency for detecting surroundings of the motor vehicle by a processor;
modulating the first detection signal onto an optical carrier signal by the processor;
transmitting the optical carrier signal with the modulated first detection signal to a transmitter of the radar sensor device by the processor;
frequency-converting the first detection signal to a second detection signal with a second frequency that is different from the first frequency by the transmitter; and
emitting the first detection signal into the surroundings using a first transmission antenna of the transmitter and emitting the second detection signal into the surroundings by a second transmission antenna of the transmitter.

2. The method of claim 1, wherein the first detection signal and the second detection signal are emitted at the same time.

3. The method of claim 1, wherein the first detection signal and the second detection signal are emitted at different points in time.

4. The method of claim 1, wherein the second detection signal is emitted at a higher frequency than the first detection signal.

5. The method of claim 1, wherein the transmitter is provided as an electronic-photonic co-integrated chip.

6. The method of claim 1, wherein the first detection signal and/or the second detection signal is amplified prior to emission by the transmitter.

7. The method of claim 1, wherein, depending on the first detection signal, a reflected first reflection signal and, depending on the second detection signal, a reflected second reflection signal is received by a receiver of the radar sensor device.

8. The method of claim 7, wherein an evaluation of the first reflection signal and an evaluation of the second reflection signal are carried out by the processor.

9. The method of claim 8, wherein an individual evaluation of the first reflection signal and an individual evaluation of the second reflection signal are carried out by the processor or a joint evaluation of the first reflection signal and of the second reflection signal is carried out.

10. The method of claim 8, wherein the first reflection signal and the second reflection signal are evaluated coherently or incoherently.

11. The method of claim 7, wherein the first transmission antenna and a first receiving antenna are co-integrated in a first element and/or the second transmission antenna and a second receiving antenna are co-integrated in a second element.

12. The method of claim 7, wherein the first reflection signal and the second reflection signal are modulated onto an optical carrier signal and transmitted to the processor.

13. The method of claim 7, wherein the receiver is provided with a ring line.

14. The method of claim 1, wherein, depending on the first detection signal, at least a third detection signal is frequency-converted and at least additionally the third detection signal is emitted into the surroundings.

15. A radar sensor device for a motor vehicle, comprising at least a processor and a transmitter, wherein the radar sensor device is configured to:
generate a first detection signal with a first frequency for detecting surroundings of the motor vehicle by the processor;
modulating the first detection signal onto an optical carrier signal by the processor;
transmitting the optical carrier signal with the modulated first detection signal to the transmitter of the radar sensor device by the processor;
frequency-converting the first detection signal to a second detection signal with a second frequency that is different from the first frequency by the transmitter; and
emitting the first detection signal into the surroundings using a first transmission antenna of the transmitter and emitting the second detection signal into the surroundings by a second transmission antenna of the transmitter.

16. The radar sensor device of claim 15, wherein the first detection signal and the second detection signal are emitted at the same time.

17. The radar sensor device of claim 15, wherein the first detection signal and the second detection signal are emitted at different points in time.

18. The radar sensor device of claim 15, wherein the second detection signal is emitted at a higher frequency than the first detection signal.

19. The radar sensor device of claim 15, wherein the transmitter is provided as an electronic-photonic co-integrated chip.

20. The radar sensor device of claim 15, wherein the first detection signal and/or the second detection signal is amplified prior to emission by the transmitter.
